(19) United States
(12) Patent Application Publication
(10) Pub. No.: US 2017/0079304 A1
(43) Pub. Date: Mar. 23, 2017

(54) MULTI-TEXTURED CHEWING GUM AND METHODS OF MAKING THEREOF

(71) Applicant: INTERCONTINENTAL GREAT BRANDS LLC, EAST HANOVER, NJ (US)

(72) Inventors: Ornauma Amornrattananukool, East Hanover, NJ (US); Brooke Davis, East Hanover, NJ (US); Deborah Levenson, East Hanover, NJ (US); Aditi Shetty, East Hanover, NJ (US); Justine Tufaro, East Hanover, NJ (US)

(21) Appl. No.: 15/309,196

(22) PCT Filed: May 15, 2015
(86) PCT No.: PCT/US2015/030983

§ 371 Date: Nov. 6, 2016

Related U.S. Application Data
(60) Provisional application No. 61/993,630, filed on May 15, 2014.

(51) Int. Cl. A23G 4/20

(52) U.S. Cl. CPC A23G 4/20; A23V 2002/00

(57) ABSTRACT

Disclosed herein are multi-textured chewing gum products that deliver a unique texture and taste experience when chewed and an exciting visual effect. By combining at least two different regions of chewing gum in a single product, each differing in texture from one another, and optionally differing in flavors, colors, or aromas from one another, a product is created that exhibits multi-sensory attributes (textural, appearance, flavor, and the like) leading to a more exciting chewing experience for the consumer.

### BACKGROUND

Traditional slab and stick chewing gum is generally prepared with a mixture of chewing gum base and powder sweeteners. These chewing gums are typically uncoated and have a uniform composition throughout the entire piece, thereby providing only a single texture and flavor when chewed. Consumers seeking a more exciting chewing experience will not encounter it with these products.

There remains a need in the art for new chewing gum that can deliver a dynamic chew texture, varied flavors, and varied colors within a single piece of chewing gum.

### SUMMARY

In an embodiment, a multi-textured chewing gum product comprises a crunch particulate chewing gum composition layer, and a non-crunch particulate chewing gum composition layer in contiguous contact with the crunch particulate chewing gum composition layer; the crunch particulate chewing gum composition layer comprising a gum base, a bulk sweetener, and a plurality of crunch particulates distributed throughout the crunch particulate chewing gum composition; the non-crunch particulate chewing gum composition layer comprising a gum base, a bulk sweetener, and optionally a plurality of color particulates distributed throughout the non-crunch particulate chewing gum composition, where the non-crunch particulate chewing gum composition is free of crunch particulates; where the multi-textured chewing gum product is uncoated; and wherein: i. the multi-textured chewing gum product has an initial crunch characteristic determined by a Texture Analyzer Test where there are at least two positive slopes and at least one negative slope in a stress versus probe penetration (%) curve and at least one negative slope that covers a stress range of at least 0.5, at least 0.75, or at least 1.0 million pascals, wherein the Texture Analyzer Test provides results as stress versus probe penetration (%); or ii. the multi-textured chewing gum product has an initial crunch characteristic determined by a Texture Analyzer Test that requires at least 2 million pascals stress during the first 10% of probe penetration into the product, wherein the Texture Analyzer Test provides results as stress versus probe penetration (%); or iii. the multi-textured chewing gum product has an initial crunch characteristic determined by a Texture Analyzer Test where the difference between a maximum stress value and a minimum stress value between 20% and 80% probe penetration into the product is at least 2.5, specifically at least 3.0 million pascals, wherein the Texture Analyzer Test provides results as stress versus probe penetration (%); or iv. a combination thereof.

In an embodiment, a multi-textured chewing gum product comprises at least two chewing gum composition layers, wherein at least one chewing gum composition layer comprises a plurality of crunch particulates distributed throughout the chewing gum composition, and optionally where the multi-textured chewing gum product is uncoated; and wherein i. the multi-textured chewing gum product has an initial crunch characteristic determined by a Texture Analyzer Test where there are at least two positive slopes and at least one negative slope in a stress versus probe penetration (%) curve and at least one negative slope that covers a stress range of at least 0.5, at least 0.75, or at least 1.0 million pascals, wherein the Texture Analyzer Test provides results as stress versus probe penetration (%); or ii. the multi-textured chewing gum product has an initial crunch characteristic determined by a Texture Analyzer Test that requires at least 2 million pascals stress during the first 10% of probe penetration into the product, wherein the Texture Analyzer Test provides results as stress versus probe penetration (%); or iii. the multi-textured chewing gum product has an initial crunch characteristic determined by a Texture Analyzer Test where the difference between a maximum stress value and a minimum stress value between 20% and 80% probe penetration into the product is at least 2.5, specifically at least 3.0 million pascals, wherein the Texture Analyzer Test provides results as stress versus probe penetration (%); or iv. a combination thereof.

Other embodiments are directed to methods of making the chewing gum products.

The above described and other features are exemplified by the following detailed description.

### BRIEF DESCRIPTION OF THE DRAWINGS

The accompanying drawings incorporated in and forming a part of the specification:

FIG. 1A. Stress-strain curves for multi-textured chewing gum product and a stress-strain curve for a comparative uncoated, slab chewing gum (the curve depicted as a dashed line) measured using a Texture Analyzer Test.

FIG. 1B. Stress-strain curves for multi-textured chewing gum product measured using a Texture Analyzer Test.

FIG. 2. Stress-strain curves for comparative chewing gums C1 and C4 measured using a Texture Analyzer Test.

FIG. 3. Stress-strain curves for comparative chewing gums C2 and C4 measured using a Texture Analyzer Test.

FIG. 4. Stress-strain curves for comparative chewing gums C3 and C4 measured using a Texture Analyzer Test.

FIG. 5. Stress-strain curves for comparative chewing gum C4 measured using a Texture Analyzer Test.

### DETAILED DESCRIPTION

Disclosed herein are multi-textured chewing gum products that deliver a unique texture and taste experience when chewed and an exciting visual effect. By combining at least two different regions of chewing gum in a single product, each differing in texture from one another, and optionally differing in flavors, colors, or aromas from one another, a product is created that exhibits multi-sensory attributes (textural, appearance, flavor, and the like) leading to a more exciting chewing experience for the consumer.

In an embodiment, the multi-textured chewing gum product generally comprises a crunch particulate chewing gum composition layer and a non-crunch particulate chewing gum composition layer in contiguous contact with the crunch particulate chewing gum composition layer; the crunch particulate chewing gum composition layer comprising a plurality of crunch particulates distributed throughout the crunch particulate chewing gum composition; and the non-crunch particulate chewing gum composition layer free of crunch particulates and optionally comprising a plurality of color particulates distributed throughout the non-crunch particulate chewing gum composition.

In another embodiment, a multi-textured chewing gum product comprises at least two chewing gum composition layers, wherein at least one chewing gum composition layer comprises a plurality of crunch particulates distributed throughout the chewing gum composition, and optionally where the multi-textured chewing gum product is uncoated. Within this embodiment, the multi-textured chewing gum product can comprise two chewing gum composition layers wherein a first chewing gum composition layer comprises a plurality of crunch particulates and a second chewing gum composition layer comprises a plurality of color particulates, a plurality of crunch particulates, or both distributed throughout the second chewing gum composition layer; and the first chewing gum composition layer is in contiguous contact with the second chewing gum composition layer.

In an embodiment, the multi-textured chewing gum product is uncoated so that each layer is visible as well as the crunch particulates or optional color particulates contained therein.

Other embodiments have three, four, five, six or more layers of different chewing gum compositions each differing by the presence or absence of the crunch particulates and optional color particulates.

The multi-textured chewing gum product comprising the crunch particulates provides a firm, gritty longer lasting crunchy texture experience compared to the crunch experienced with hard coated chewing gum pellets.

In an embodiment, the multi-textured chewing gum product has visual characteristics of a multi-textured and a multi-colored product by the presence of different colors in each layer as well as a different color for each of the crunch particulate and optional color particulate. These visual cues, where the layers are visually distinct from one another, inform the consumer that the product is more than a traditional chewing gum. Consumers associate the color particulates with the crunch or release of flavor as the product is chewed.

In an embodiment, the multi-textured chewing gum product can have different flavors or aromas between the different layers as well as different flavors in the crunch particulate, the color particulate, or a combination thereof.

In an embodiment, the multi-textured chewing gum product can have a weight ratio of crunch particulate chewing gum composition layer to non-crunch particulate chewing gum composition layer of about 90:10 to about 10:90, specifically about 80:20 to about 20:80, more specifically about 70:30 to about 30:70, yet more specifically about 60:40 to about 40:60, still yet more specifically about 55:45 to about 45:55, and specifically about 50:50. In an embodiment, the non-crunch particulate chewing gum composition layer comprises a plurality of color particulates.

### Chewing Gum Compositions

In general the chewing gum composition with crunch particulates, “crunch particulate chewing gum composition”, comprises a plurality of crunch particulates, a gum base or gum base polymer, and a bulk sweetener; and the chewing gum composition free of crunch particulates, “non-crunch particulate chewing gum composition”, comprises a gum base or gum base polymer, a bulk sweetener, and optionally a plurality of color particulates where the non-crunch particulate chewing gum composition is free of crunch particulates as described herein. When the non-crunch particulate chewing gum composition comprises color particulates, it may also be referred to herein as a “color particulate chewing gum composition”.

The crunch particulate can be a crystalline sugar polyol particulate. In addition, the crunch particulates differ from the chewing gum bulk sweetener by size and optionally further by composition.

The crunch particulate can be prepared from a saccharide, a sugar-free sweetener, or a combination thereof. Exemplary sugar-based sweeteners include saccharides including mono-saccharides, di-saccharides and poly-saccharides, for example, sucrose (sugar), dextrose, maltose, dextrin, xylose, ribose, glucose, mannose, galactose, fructose (levulose), lactose, or a combination thereof.

Exemplary sugar-free sweeteners include sugar alcohols such as erythritol, galactitol, isomalt, a hydrogenated starch hydrolyzate, lactitol, maltitol, mannitol, polyglycitol, sorbitol, xylitol, and the like, or a combination thereof. The sugar alcohol can be in crystalline form.

In an embodiment, the crunch particulate comprises crystalline isomalt. Isomalt consists of disaccharide alcohols. Isomalt can be prepared by hydrogenating isomaltulose. Products of the hydrogenation can include 6-O-α-D-glucopyranosyl-D-sorbitol (1,6-GPS); 1-O-α-D-glucopyranosyl-D-sorbitol (1,1-GPS); 1-O-α-D-glucopyranosyl-D-mannitol (1,1-GPM); 6-O-α-D-glucopyranosyl-D-mannitol (1,6-GPM); and mixtures thereof. Some commercially available isomalt materials include an almost equimolar mixture of 1,6-GPS, and 1,1-GPM. Other isomalt materials can include pure 1,6-GPS; pure 1,1-GPS; pure 1,6-GP; or pure 1,1-GPM. Still other isomalt materials can include mixtures of 1,6-GPS; 1,1-GPS; 1,6-GPM; and 1,1-GPM at any ratio. Exemplary commercially available isomalt includes Isomalt ST, including Isomalt ST-M and Isomalt ST-PF, Isomalt GS, Isomalt M, Isomalt DC, and Isomalt LM available from BENEO-Palatinit, Südzucker Group. Isomalt ST has an almost equimolar mixture of 1,6-GPS (43-57%) and 1,1-GPM. Isomalt GS contains 1,6-GPS (75-80%) and 1,1-GPM.

In an embodiment, the isomalt of the crunch particulate has an almost equimolar mixture of 1,6-GPS and 1,1-GPM. In another embodiment, the isomalt of the crunch particulate has a mixture of 1,1-GPM and 75-80% 1,6-GPS.

The crunch particulate may further comprise a flavorant, a high intensity sweetener, a sensate, a coloring agent, or a combination thereof. Any of the flavorants, high intensity sweetener, sensate, or coloring agent, described herein for use to prepare the chewing gum composition can be used to flavor the crunch particulate.

The crunch particulate has a size and hardness that provides a satisfying crunch when a chewing gum product containing the particulate is chewed. The crunch particulates are much larger in size than the bulk sweetener used to prepare chewing gum, the bulk sweetener size can typically range from 0.1 to 0.5 mm. In an embodiment, the particle size range of the crunch particulate is at least 90% greater than 0.8 mm; no more than 10%>1.25 mm based on sieve analysis. In an embodiment, the particle size range of the crunch particulate is about 0.5 to about 1.4 mm, specifically about 0.63 to about 1.3 mm, and yet more specifically about 0.8 to about 1.25 mm based on sieve analysis.

The amount of crunch particulate present in the crunch particulate chewing gum compositions can be about 5 to about 30 weight percent (“wt %”) based on the total weight of the crunch particulate chewing gum composition, specifically about 10 to about 25 wt %, and more specifically about 15 to about 20 wt %.

The amount of crunch particulate present based on the total weight of the multi-textured chewing gum product can be about 2.5 to about 15 wt %, specifically about 5 to about 12 wt %, and more specifically about 7 to about 10 wt %.

The color particulate comprises a colorant ingredient similar to those described herein for use in the chewing gum composition, and a carrier. Suitable carriers include bulk sweeteners as described herein, a triglyceride (e.g. medium chain triglycerides, long chain triglycerides), a hydrocolloid, or a combination thereof.

Bulk sweeteners include saccharides including mono-saccharides, di-saccharides and poly-saccharides, for example, sucrose (sugar), dextrose, maltose, dextrin, maltodextrin, xylose, ribose, glucose, mannose, galactose, fructose (levulose), lactose, or a combination thereof. Also suitable are sugar polyols such as erythritol, galactitol, isomalt, a hydrogenated starch hydrolyzate, lactitol, maltitol, mannitol, polyglycitol, sorbitol, xylitol, and the like, or a combination thereof. The sugar alcohol can be amorphous or crystalline, or used in syrup form including sorbitol syrup, maltitol syrup, hydrogenated starch hydrolysate syrup, polyglycitol syrup, and the like.

Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Modified natural gums include propylene glycol alginate, carboxymethyl locust bean gum, low methoxyl pectin, or a combination thereof. Modified celluloses can be included such as microcrystalline cellulose, carboxymethylcellulose (CMC), methylcellulose (MC), hydroxypropylmethylcellulose (HPCM), hydroxypropylcellulose (MPC), or a combination thereof.

In another embodiment, the color particulate can comprise hard boiled candy particulates, a pressed candy tablet particulates, or a combination thereof.

Additional optional ingredients in the color particulate can be a flavorant, a processing aid, a sensate (a cooling agent, a warming agent, a tingling agent, etc), or a combination thereof.

The color particulate can have a size such that it is visible to the naked eye, but small enough so that it does not impart a crunch or texture. In an embodiment, the size of the color particulate can be less than or equal to the size of the bulk sweetener used in the chewing gum composition.

Alternatively, the amount of color particulate used in the color particulate chewing gum composition is sufficiently low so as to not impart much of a crunch or texture, if at all, but is still able to impart a distinct visual impression of speckles in the chewing gum. In an embodiment, the particle size is at least 95% greater than 0.85 mm. In an embodiment, the particle size range of the color particulate is about 0.1 to about 1.0 mm, specifically about 0.25 to about 0.85 mm, and yet more specifically about 0.45 to about 0.6 mm based on sieve analysis.

The hardness of the color particulate can be less than the crunch particulate.

The amount of color particulate present in the color particulate chewing gum composition can be about 0.1 to about 2.0 wt % based on the total weight of the color particulate chewing gum composition, specifically about 0.3 to about 1.7 wt %, and more specifically about 0.5 to about 1.5 wt %.

The amount of color particulate present based on the total weight of the multi-textured chewing gum product can be about 0.05 to about 1.0 wt %, specifically about 0.15 to about 0.8 wt %, and more specifically about 0.25 to about 0.75 wt %.

In an embodiment, the crunch particulate chewing gum composition can further comprise a plurality of color particulates. Within this embodiment, it will still be characterized as a “crunch particulate chewing gum composition” and not a color particulate chewing gum composition.

The gum base can comprise an elastomer and optionally an additional gum base ingredient, wherein the additional gum base ingredient is a resin, a fat, an emulsifier, a wax, a filler, a softener, a plasticizer, an antioxidant, or a combination thereof.

As used herein, the term “gum base” refers to water insoluble material(s) and can include, for example, elastomers, resins, waxes, elastomer solvents, emulsifiers, plasticizers, bulking agents/fillers, fats, or a combination thereof.

The amount of gum base employed will vary depending upon various factors such as the type of base used, the consistency of the chewing gum desired, and the other components used in the composition to make the final chewing gum product. In general, the gum base will be present in amounts of about 5 to about 65 wt % based on the total weight of the chewing gum composition (either the crunch particulate chewing gum composition or the color particulate chewing gum composition), specifically about 10 to about 55 wt %, more specifically about 15 to about 45 wt %, and yet more specifically about 20 to about 35 wt %.

Exemplary elastomers to be used in the chewing gum base include both natural and synthetic elastomers and rubbers, for example, substances of vegetable origin such as chicle, crown gum, nispero, rosadinha, jelutong, perillo, niger gutta, tunu, balata, gutta-percha, lechi-capsi, sorva, gutta kay, and the like, or a combination thereof. Synthetic elastomers such as butadiene-styrene copolymers, polyisobutylene, isobutyleneisoprene copolymers, polyethylene, a combination thereof, and the like, or a combination thereof are also useful. The gum base can include a non-toxic vinyl polymer, such as polyvinyl acetate and its partial hydrolysate, polyvinyl alcohol, or a combination thereof. When utilized, the molecular weight of the vinyl polymer can range from about 3,000 up to and including about 94,000. Additional useful polymers include: crosslinked polyvinyl pyrrolidone, polymethylmethacrylate; copolymers of lactic acid, polyhydroxyalkanoates, plasticized ethylcellulose, polyvinyl acetatephthalate, or a combination thereof.

Conventional additives can be included in the gum base in effective amounts such as plasticizers or softeners to provide a variety of desirable textures and consistency properties. Because of the low molecular weight of these components, the plasticizers and softeners are able to penetrate the fundamental structure of the gum base making it plastic and less viscous. Suitable plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerin, or a combination thereof. Some of these ingredients may be added at the time of gum base formation or added later during the production of the chewing gum composition.

Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, and the like, or a combination thereof, can also be incorporated into the gum base to obtain a variety of desirable textures and consistency properties.

When a wax is present in the gum base, it softens the polymeric elastomer mixture and improves the elasticity of the gum base. The waxes employed may have a melting point below about 60° C., and specifically between about 45° C. and about 55° C. The low melting wax can be a paraffin wax. The wax can be present in the gum base in an amount of about 0.1 to about 10 wt %, and specifically about 3 to about 7 wt % based on the total weight of the gum base.

In addition to the low melting point waxes, waxes having a higher melting point can be used in the gum base in amounts up to about 5 wt % based on the total weight of the gum base. Such high melting waxes include beeswax, vegetable wax, candelilla wax, carnuba wax, most petroleum waxes, and the like, or a combination thereof.

The gum base (or optionally the chewing gum) can contain a fat. Exemplary fats include fats and oils of vegetable origin, animal origin, or a combination thereof. Suitable vegetable fats can include soybean, cottonseed, corn, almond, peanut, sunflower, rapeseed, olive, palm, palm kernel, illipe, shea, coconut, cocoa, cocoa butter, or a combination thereof. The forgoing vegetable fats can be hydrogenated to varying degrees as desired or separated by fractional crystallization. Suitable animal fats include dairy fats such as milk fat and butter. As used herein, the term “fat” refers to any lipid material and can be solid or liquid (e.g. oil). Exemplary lipid materials include triglycerides, fatty alcohols, fatty acids, or a combination thereof. The triglyceride is not limited although medium chain triglycerides, long chain triglycerides, and the like can be used. The melting point of the fat is not limited although fats having a melting point of about 15 to about 68° C. can be used. Specific fats include hydrogenated palm oil, hydrogenated palm kernel oil, hydrogenated soybean oil, hydrogenated peanut oil, hydrogenated cottonseed oil, hydrogenated coconut oil, or a combination thereof.

The gum base can optionally contain conventional elastomer solvents to aid in softening the elastomer base component, for example resins such as polymers of alpha-pinene or beta-pinene; methyl, glycerol or pentaerythritol esters of rosins or modified rosins and gums, such as hydrogenated, dimerized or polymerized rosins, or a combination thereof the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like; or a combination thereof. The elastomer solvent can be used in amounts of about 5 to about 75 wt % base on the total weight of the gum base, and specifically about 45 to about 70 wt %.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, tricalcium phosphate and the like, or a combination thereof. These fillers or adjuvants can be used in the gum base in various amounts. Specifically the amount of filler, when used, can be present in an amount of about 5 to about 60 wt % based on the total weight of the gum base, and more specifically about 20 to about 30 wt %.

Suitable emulsifiers for use in the gum base include distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, tweens, spans, stearoyl lactylates, calcium stearoyl-2-lactylate, sodium stearoyl-2-lactylate, lecithin, ammonium phosphatide, sucrose esters of fatty acids, sucroglycerides, propane-1,2-diol esters of fatty acids, or a combination thereof.

The bulk sweetener of the chewing gum composition (either the crunch particulate chewing gum composition or the color particulate chewing gum composition) can be a sugar-based or sugar-free bulk sweetener, specifically sugar-free. Bulk sugar sweeteners generally include saccharides. Suitable sugar sweeteners include mono-saccharides, di-saccharides and poly-saccharides, for example, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, such as high fructose corn syrup, or a combination thereof.

The bulk sweetener can also be a sugar-free bulk sweetener such as a sugar alcohol, also referred to as a “sugar polyol”. The sugar alcohol can be erythritol, galactitol, isomalt, a hydrogenated starch hydrolyzate, lactitol, maltitol, mannitol, polyglycitol, sorbitol, xylitol, and the like, or a combination thereof. The sugar alcohol can be in powder form (either crystalline or amorphous), molten (melted) form having a low moisture content (e.g. less than 10 wt %, specifically less than 5 wt %), or in syrup form (also referred to as “solution”) with water. Exemplary sugar alcohol syrups include sorbitol syrup, maltitol syrup, hydrogenated starch hydrolysate syrup, polyglycitol syrup, and the like.

The amount of bulk sweetener in the chewing gum composition can be about 10 to about 85 wt % based on the total weight of the chewing gum composition, specifically about 20 to about 80 wt %, more specifically about 30 to about 75 wt %, and yet more specifically about 40 to about 70 wt %.

In an embodiment, the chewing gum composition is sugar-free.

The chewing gum composition may further comprise an additional ingredient wherein the additional ingredient is a flavorant, a fat, a high intensity sweetener, a food acid or salt thereof, a sensate, a flavor modulator or potentiator, a coloring agent, a humectant, a softener, or a combination thereof.

Exemplary flavorants (flavor, flavoring agent) for use in the chewing gum composition can include those artificial or natural flavors known in the art, for example synthetic flavor oils, natural flavoring aromatics and/or oils, oleoresins, extracts derived from plants, leaves, flowers, fruits, and the like, or a combination thereof. Nonlimiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, or a combination thereof.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin).

The flavorant can be used in liquid or solid form. The flavorant can be used in free form or encapsulated form. When used in solid (dry) form, suitable drying means such as spray drying a flavor oil can be used. Alternatively, the flavorant can be encapsulated, absorbed onto water soluble materials by means known in the art, for example cellulose, starch, sugar, maltodextrin, gum arabic, and the like. In an embodiment, the flavorant can be used in physical forms effective to provide an initial burst of flavor or a prolonged sensation of flavor.

More than one flavorant can be used in the chewing gum composition. The amount and type of flavorant can be chosen based on the targeted release profile and flavor intensity desired. The chewing gum composition generally comprises a flavorant in an amount of about 0.001 to about 5 wt % based on the total weight of the chewing gum composition, specifically about 0.01 to about 4 wt %, yet more specifically about 0.1 to about 3 wt %, and still yet more specifically about 1.0 to about 2 wt %.

The chewing gum composition may further contain a high intensity sweetener. A “high intensity sweetener” as used herein means agents having a sweetness greater than the sweetness of sucrose. In an embodiment, a high intensity sweetener has a sweetness that is at least 100 times that of sugar (sucrose) on a per weight basis, specifically at least 500 times that of sugar on a per weight basis. In an embodiment the high intensity sweetener is at least 1,000 times that of sugar on a per weight basis, more specifically at least 5,000 times that of sugar on a per weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Combinations comprising one or more sweeteners or one or more of the foregoing types of sweeteners can be used. Without being limited to particular sweeteners, representative categories and examples include:

water-soluble sweetening agents such as dihydrochalcones, monellin, steviosides, rebaudiosides, glycyrrhizin, dihydroflavenol, monatin, and L-aminodicarboxylic acid aminoalkenoic acid ester amides, such as those disclosed in U.S. Pat. No. 4,619,834, or a combination thereof;

water-soluble artificial sweeteners such as soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination thereof; dipeptide based sweeteners, for example the L-aspartic acid derived sweeteners such as L-aspartyl-L-phenylalanine methyl ester (Aspartame) and materials described in U.S. Pat. No. 3,492,131, L-alpha-aspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, neotame, or a combination thereof;

water-soluble sweeteners derived from naturally occurring water-soluble sweeteners, such as steviosides and stevia derived compounds, for example, steviol glycosides such as rebaudiocides including rebaudiocide A, and the like, lo han quo and lo han quo derived compounds such as iso-mogroside V and the like, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include, for example: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; 4,6,1′,6′-tetradeoxy-sucrose, or a combination thereof;

protein based sweeteners such as thaumaoccous danielli, talin, or a combination thereof; and

amino acid based sweeteners.

Furthermore, the high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, or a combination thereof.

The chewing gum composition may optionally further comprise a coloring agent. Coloring agents (colors, colorants, colorings) can be used in amounts effective to produce a desired color for the chewing gum. Suitable coloring agents include pigments, which can be incorporated in amounts up to about 6 wt % based on the total weight of the chewing gum. For example, titanium dioxide can be incorporated in amounts up to about 2 wt %, and specifically less than about 1 wt % based on the total weight of the chewing gum. Suitable coloring agents also include natural food colors and dyes suitable for food, drug, and cosmetic applications.

Suitable colors include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), or a combination thereof. In an embodiment, certified colors can include FD&C aluminum lakes, or a combination thereof. A full recitation of all FD& C colorants and their corresponding chemical structures may be found in the Kirk-Othmer Encyclopedia of Chemical Technology, 4th Edition, in volume 1 at pages 492-494.

Exemplary food acids or salts thereof for use in the chewing gum can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and alkali metal salts thereof (e.g., sodium citrate dihydrate), or a combination thereof. The food acid or salt thereof may be used in free form or in an encapsulated form.

The chewing gum composition may comprise a sensate. Exemplary sensates include cooling agents, warming agents, tingling agents, effervescent agents, or a combination thereof. Cooling agents (“coolants”) are additives that provide a cooling or refreshing effect in the mouth, in the nasal cavity, or on skin. For example, among the useful cooling agents are included menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-2,2-diisopropylbutanamide, N-ethyl-p-menthane-3-carboxamide (WS-3), ethyl ester of N-[[5-methyl-2-(1-methylethyl)cyclohexyl]carbonyl]glycine (WS-5), as well as the substantially pure ethyl ester of N-[[5-methyl-2-(1-methylethyl)cyclohexyl]carbonyl]glycine as disclosed in U.S. Pat. No. 7,189,760 to Erman, et al which is incorporated in its entirety herein by reference, isopulegol, menthyloxy propane diol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, N-(4-cyanomethylphenyl) p-menthanecarboxamide (G-180), Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; Menthol methyl ether, menthyl pyrrolidone carboxylate; 2,5-dimethyl-4-(1-pyrrolidinyl)-3(2H)-furanone; cyclic α-keto enamines, cyclotene derivatives such as cyclopentenes including 3-methyl-2-(1-pyrrolidinyl)-2-cyclopenten-1-one and 5-methyl-2-(1-pyrrolidinyl)-2-cyclopenten-1-one, compounds of the formula:

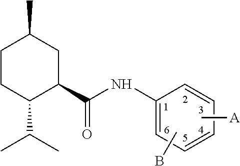

wherein B is selected from H, CH₃, C₂H₅, OCH₃, OC₂H₅; and OH; and wherein A is a moiety of the formula —CO-D, wherein D is selected from the following moieties: (i) —NR¹R², wherein R¹ and R² are independently selected from H and C₁-C₈ straight or branched-chain aliphatic, alkoxyalkyl, hydroxyalkyl, araliphatic and cycloalkyl groups, or R¹ and R² together with the nitrogen atom to which they are attached form part of an optionally-substituted, five- or six-membered heterocyclic ring; (ii) —NHCH₂COOCH₂CH₃, —NHCH₂CONH₂, —NHCH₂CH₂OCH₃, —NHCH₂CH₂OH, —NHCH₂CH(OH)CH₂OH and (iii) a moiety selected from the group consisting of:

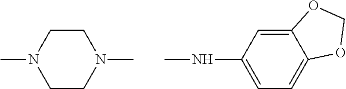

as disclosed in PCT Patent Application WO2006/125334 to Bell et al. which is incorporated in its entirety herein by reference, among others; or a combination thereof. Other compounds include the alpha-keto enamines disclosed in U.S. Pat. No. 6,592,884 to Hofmann et al. which is incorporated in its entirety herein by reference. These and other suitable cooling agents are further described in the following U.S. patents, all of which are incorporated in their entirety by reference hereto: U.S. Pat. Nos. 4,230,688; 4,032,661; 4,459,425; 4,178,459; 4,296,255; 4,136,163; 5,009,893; 5,266,592; 5,698,181; 6,277,385; 6,627,233; 7,030,273. Still other suitable cooling agents are further described in the following U.S. Published Patent Applications, all of which are incorporated in their entirety by reference hereto: U.S. 2005/0222256; 2005/0265930.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming agents included are vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamylether, vanillyl alcohol n-hexylether, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropol alcohol, iso-amylalcohol, benzyl alcohol, glycerine, or a combination thereof.

In an embodiment, tingling agents may be employed to provide a tingling, stinging or numbing sensation to the user. Tingling agents include, but are not limited to: Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; perillartine; 4-(1-menthoxymethyl)-2-phenyl-1,3-dioxolane; black pepper extract (piper nigrum), including the active ingredients chavicine and piperine; Echinacea extract; Northern Prickly Ash extract; trans-pellitorin, and red pepper oleoresin; or a combination thereof. In an embodiment, alkylamides extracted from materials such as jambu or sanshool may be included. Additionally, in an embodiment, a sensation is created due to effervescence. Such effervescence is created by combining an alkaline material with an acidic material, either or both of which may be encapsulated. In an embodiment, an alkaline material may include alkali metal carbonates, alkali metal bicarbonates, alkaline earth metal carbonates, alkaline earth metal bicarbonates or a combination thereof. In an embodiment, an acidic material may include acetic acid, adipic acid, ascorbic acid, butyric acid, citric acid, formic acid, fumaric acid, glyconic acid, lactic acid, phosphoric acid, malic acid, oxalic acid, succinic acid, tartaric acid or a combination thereof. Examples of “tingling” type sensates include those disclosed in U.S. Pat. Nos. 6,780,443, 6,159,509, 5,545,424, and 5,407,665, each of which is incorporated by reference herein in its entirety.

The chewing gum composition may optionally further comprise a flavor modulator or potentiator. A sweet taste can come from flavor modulators or potentiators and/or from flavorants as well as from sweeteners. Flavor potentiators can consist of materials that intensify, supplement, modify or enhance the taste or aroma perception of an original material without introducing a characteristic taste or aroma perception of their own. Flavor modulators can impart a characteristic of their own that complements or negates a characteristic of another component. In an embodiment, flavor modulators or potentiators are designed to intensify, supplement, modify, or enhance the perception of flavor, sweetness, tartness, umami, kokumi, saltiness or a combination thereof can be included. Thus, the addition of flavor modulators or potentiators can impact the overall taste of the chewing gum. For example, flavors can be compounded to have additional sweet notes by the inclusion of flavor modulators or potentiators, such as vanilla, vanillin, ethyl maltol, furfual, ethyl propionate, lactones, or a combination thereof.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), or a combination thereof. In an embodiment, sugar acids, sodium chloride, potassium chloride, sodium acid sulfate, or a combination thereof are used. In an embodiment, glutamates such as monosodium glutamate, monopotassium glutamate, hydrolyzed vegetable protein, hydrolyzed animal protein, yeast extract, or a combination thereof are included. Further examples include adenosine monophosphate (AMP), glutathione, and nucleotides such as inosine monophosphate, disodium inosinate, xanthosine monophosphate, guanylate monophosphate, or a combination thereof. Further examples of flavor potentiator compositions that impart kokumi are also included in U.S. Pat. No. 5,679,397 to Kuroda et al.

The amount of flavor modulators, flavor potentiators, and flavorants used herein can be a matter of preference subject to such factors as the type of final product composition, the individual flavor, and the strength of flavor desired. Thus, the amount of flavoring can be varied in order to obtain the result desired in the final product and such variations are within the capabilities of those skilled in the art without the need for undue experimentation.

The chewing gum composition may optionally further comprise a humectant. Exemplary humectants include glycerin, propylene glycol, polyethylene glycol, or a combination thereof. The amount of humectant can be controlled to ensure the final chewing gum product does not unduly absorb moisture from the surrounding environment during production, packaging, storage, and use.

The chewing gum composition may further include a softener, such as those described herein for use in the gum base.

The chewing gum composition can be prepared using standard techniques and equipment known in the art.

In one exemplary process, a gum base is heated to a temperature sufficiently high to soften the gum base without adversely affecting the physical and chemical make up of the gum base, which will vary depending upon the composition of the gum base used, and is readily determined by those skilled in the art without undue experimentation. For example, the gum base can be conventionally melted to about 40° C. to about 160° C., or melted to about 150° C. to about 175° C., for a period of time sufficient to render the base molten, e.g., about thirty minutes, just prior to being admixed incrementally with the remaining ingredients of the gum base, if any, such as the plasticizer, fillers, and softener to plasticize the blend as well as to modulate the hardness, viscoelasticity and formability of the base. The chewing gum ingredients are next blended with the molten gum base where the crunch particulates (for the crunch particulate chewing gum composition) and the color particulates (for the color particulate chewing gum composition) are typically added toward the latter stages of the mixing process to maintain their size, and for the crunch particulate, its crunch. Mixing is continued until a uniform or homogeneous mixture of the chewing gum composition is obtained.

In another exemplary process, chewing gum ingredients are mixed with gum base without prior melting of the gum base or gum base ingredients. Mixing is continued until a uniform or homogeneous mixture of the chewing gum composition is obtained. Within this embodiment, the gum base can be in the form of a pelletized gum base that can be softened at 40 to 50° C. rather than melting at higher temperatures.

In another embodiment, a combination of melted gum base and pelletized gum base can be used.

The multi-textured chewing gum product generally comprises two, three, four, or more layers. In an embodiment, at least one layer, but not all, comprises the crunch particulates. In another embodiment, all the layers contain the crunch particulates. The formation of the multi-textured chewing gum products can be formed by a coextrusion process, a laminate process, a compression process, a rolling and scoring process, a chain die process, a rotary die process, or a cut and wrap process, or a combination thereof. The compositions used to make the multi-textured chewing gum can be formed using a batch method or a continuous method.

In an embodiment, the chewing gum composition is prepared in a continuous process as described in International Application Publication WO2013158291 System and Method for Manufacturing Chewing Gum filed 15 Mar. 2013, which is incorporated by reference herein in its entirety.

In some embodiments, the multi-textured chewing gum is prepared into discrete units using a chain die, or rolling and scoring process.

The multi-textured chewing gum products can be prepared into discrete units in the form of slabs, sticks, pellets, cubes, and the like. The formation into discrete units can be achieved using a chain die, or rolling and scoring process.

In an embodiment, a guillotine knife is used to cut the multi-textured chewing gum into discrete units having visually distinct layers on one, two, three, four or more sides of the unit. Optionally, in place of a dusting media (e.g., dusting powder, rolling compound and the like), an edible oil anti-adherent may be used to prevent the chewing gum from sticking to the knives or other processing equipment. The oil may be applied directly to the chewing gum prior to cutting. Exemplary oil anti-adherent includes light mineral oil. In an alternative, pan release agents may be used on the processing equipment.

### Texture Analysis

The multi-textured chewing gum product exhibits different chew textures and mouthfeel compared to traditional chewing gum. In order to characterize the differences, various analytical tests were developed to characterize the difference between the multi-textured chewing gum products and traditional chewing gum at the initial bite and from initial bite to chew.

Several embodiments of the multi-textured chewing gum product have an initial chew texture that is more crunchy or otherwise different than traditional chewing gum. This provides a new and pleasing experience to the consumer. To quantitatively characterize “initial crunch”, an Initial Crunch Texture Analyzer Test (or just “Texture Analyzer Test”) as set out in Example 2 can be conducted. In general, the Texture Analyzer Test is conducted using a texture analyzer equipped with a 2 millimeter (mm) probe (cylinder, length of 25 mm) at a 1 millimeter/second probe speed and 95% probe penetration (95% of sample is being penetrated with the probe in the direction of the applied force), eight runs per sample type, and the results are provided as stress versus probe penetration (%) or stress-strain curves.

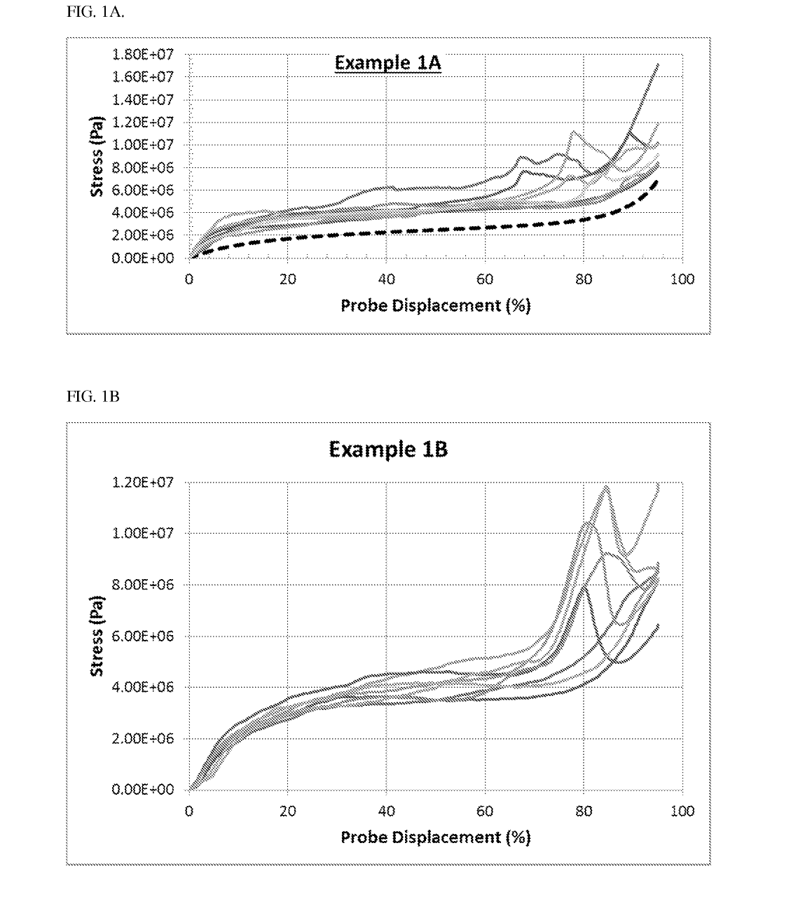

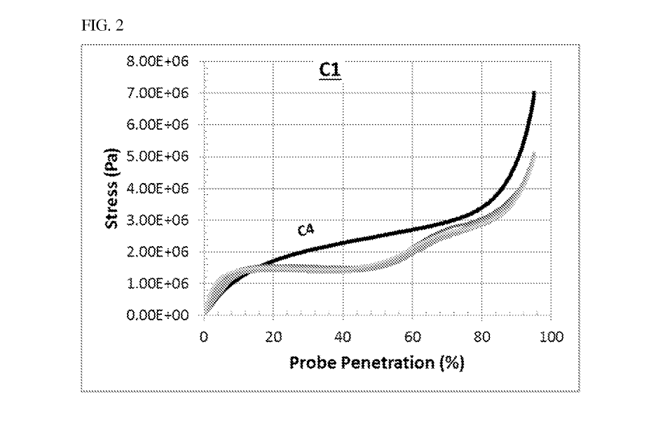

The stress versus probe penetration (%) curves (alternatively referred to as “stress-strain curves”) for the multi-textured chewing gum products differ significantly from traditional chewing gum, such as traditional uncoated slab or stick formats or hard panned coated chewing gum pellets. The traditional uncoated slab gum exhibit stress-strain curves having generally positive slopes (see e.g. FIG. 1A dashed line) and no peaks, i.e. local maxima of stress present in stress-strain curves of multi-textural chewing gum products (see e.g. FIG. 1A, solid line). A “peak” has a positive slope on one side and a negative slope on the other side. The shape and magnitude of the peaks will vary and depend on type (size, shape) and amount of each particulate; and amount of each layer. The peaks or variations in the curves represent chew resistance and correlate to the different senses perceived when a consumer performs a single bite on a sample.

In an embodiment, the multi-textured chewing gum product has an initial crunch characteristic determined by the Texture Analyzer Test where there are at least two positive slopes and at least one negative slope in a stress versus probe penetration (%) curve and at least one negative slope that covers a stress range of at least 0.5 million pascals, specifically at least 0.75 million pascals, and more specifically at least 1.0 million pascals. The “at least one negative (downward) slope covering a range of at least x million Pa” means the stress is reduced by at least x million pascals from a peak of a negative slope to where the curve changes to a positive slope or the curve ends. In an embodiment, the multi-textured chewing gum product can further have an initial crunch characteristic determined by the Texture Analyzer Test that requires at least 2 million pascals stress during the first 10% of probe penetration into the product, specifically at least 2.5 million pascals. The multi-textured chewing gum product can further have an initial crunch characteristic determined by the Texture Analyzer Test where there is a stress peak of at least 2 million pascals between 60% and 90% probe penetration into the product, specifically at least 3 million pascals, more specifically at least 4 million pascals, and yet more specifically at least 5 million pascals between 60% and 90% probe penetration into the product.

The multi-textured chewing gum product can further have an initial crunch characteristic determined by a Texture Analyzer Test where the difference between a maximum stress value and a minimum stress value between 20% and 80% probe penetration into the product is at least 2.5 million pascals, specifically at least 3.0 million pascals.

The features and advantages are more fully shown by the following examples which are provided for purposes of illustration, and are not to be construed as limiting the invention in any way.

### EXAMPLES

### Example 1

### Multi-Textured Chewing Gum with Isomalt Crunch Particulates

A dual layered, multi-textured chewing gum product is prepared with a first layer of a colored (non-white) chewing gum containing isomalt crunch particulates having a particle size range of at least 90% greater than 0.8 mm; no more than 10%>1.25 mm based on sieve analysis; and a second layer of white chewing gum optionally containing color particulates. The color chewing gum and white chewing gum are in about a 1:1 weight ratio. The components of each chewing gum composition are provided in Table 1.

TABLE 1

| | Example 1A | | Example 1B | | Example 1C | |
|---|---|---|---|---|---|---|
| | Color | White | Color | White | Color | White |
| | gum | gum | gum | gum | gum | gum |
| Ingredient | wt % | wt % | wt % | wt % | wt % | wt % |
| Gum base | 27-30 | 27-30 | 27-30 | 27-30 | 28-32 | 28-32 |
| Sugar polyol* | 38-43 | 58-63 | 44-49 | 58-63 | 32-38 | 52-60 |
| Softener and/or | 4-6 | 4-6 | 4-6 | 4-6 | 5-7 | 5-7 |
| humectant | | | | | | |
| Colorant | 0.01-0.05 | — | 0.01-0.05 | — | 0.04-0.08 | — |
| Colorant - TiO₂ | — | 0.1-0.3 | — | 0.1-0.3 | — | 0.1-0.3 |
| Additional | 5-7 | 5-7 | 5-7 | 5-7 | 7-9 | 7-9 |
| ingredient, e.g. | | | | | | |
| flavorant, food acid, | | | | | | |
| cooling agent, and/or | | | | | | |
| high intensity | | | | | | |
| sweeteners | | | | | | |
| Isomalt crunch | 18-22 | — | 12-16 | — | 18-22 | — |
| particulates | | | | | | |
| Color particulates | — | 0.3-0.7 | — | 0.3-0.7 | — | — |
| Total | 100 | 100 | 100 | 100 | 100 | 100 |

*e.g. sorbitol, maltitol, xylitol

The color chewing gum was prepared by melting the gum base until molten. Then flavors, cooling agent, and sugar polyols are added with mixing followed by the isomalt crunch particulates and high intensity sweeteners to form the color chewing gum composition. The white gum was separately prepared using a similar mixing process where the color particulates, if used, are added toward the end of the process. The two chewing gum compositions were coextruded with a dual head extruder, subjected to a calendaring process and then cut into pieces to result in a two layer chewing gum having essentially equal portions of the color chewing gum and the white chewing gum so that the final chewing gum product contained about 6-11 wt % isomalt crunch particles based on the total weight of the multi-textured chewing gum product.

### Example 2

### Initial Crunch, Texture Analyzer Test

The chewing gums of Example 1 were analyzed for initial crunch using a method that can both qualitatively and quantitatively differentiate between the initial texture for the sample compared to four comparative chewing gums as set out in Table 2.

TABLE 2

| Comparative | |
|---|---|
| samples | Description |
| “Comparative | Trident ® Layers ™ CoolMint + Melon Fresco, a chewing gum having |
| mint/melon | two outer layers of chewing gum material sandwiching a center layer |
| chewing gum” or | of flavored candy 1 stick = 2.5 grams, Ingredients: Gum base, |
| “C1” | maltitol, maltitol syrup, sorbitol, mannitol, natural and artificial |
| | flavoring, less than 2% of acesulfame potassium, aspartame, blue 1, |
| | blue1 lake, gelatin, partially hydrogenated coconut oil, soy lecithin, |
| | sucralose and yellow 5. |
| “Comparative | Ice Breakers ™ Ice Cubes Spearmint, cube-shaped chewing gum |
| chewing gum with | containing “flavor crystals”; |
| inclusions” or | Ingredients: xylitol, gum base, maltitol syrup, mannitol, contains 2% |
| “C2” | or less of: natural and artificial flavor, gum acacia, maltodextrin, soy |
| | lecithin, artificial color (blue 1 lake, yellow 5 lake, blue 1, yellow 5), |
| | aspartame, gelatin, acesulfame potassium, neotame, BHT, and |
| | sucralose. |
| “Comparative mint | Dentyne Ice ™, Mint Frost a hard coated pellet chewing gum, 1 |
| pellet chewing | piece = 1.5 grams, |
| gum” or “C3” | Ingredients: sorbitol, gum base, maltitol, mannitol, artificial and |
| | natural flavoring, less than 2% of: acacia, acesulfame potassium, |
| | aspartame, BHT, candelilla wax, glycerin, soy lecithin, sucralose, |
| | and titanium dioxide. |
| “Comparative | STRIDE ™ Spearmint Traditional slab chewing gum, 1 stick = 1.9 |
| spearmint slab | grams |
| chewing gum” or | Ingredients: sorbitol, gum base, glycerin, mannitol, xylitol, natural |
| “C4” | and artificial flavoring, less than 2% of: acesulfame potassium, |
| | aspartame, BHT, blue 1 lake, soy lecithin and yellow 5 lake. |

### Initial Crunch, Texture Analyzer Test

The initial crunch of the samples was measured using a texture analyzer (TA.XT.Plus Texture Analyser from Stable Micro Systems) with a 2 millimeter (mm) probe (cylinder, length of 25 mm) at a 1 millimeter/second probe speed and 95% probe penetration (95% of sample is being penetrated with the probe in the direction of the applied force). The samples were oriented so that the layer containing the isomalt crunch particulates was penetrated by the probe first. The sample is analyzed and the force resistance of samples is recorded as a function of time and/or penetration. The results are reported in stress versus probe penetration (%) curves. Eight runs per sample type were performed.

The stress versus probe penetration (%) curve for traditional uncoated, slab chewing gum behaves like the dashed line shown in FIG. 1A. The curve does not show any anomalies. The stress increase at large probe penetration (>90%) is related to the probe compressing the material against the platen.

The “stress-strain” curves for the samples of chewing gum of Example 1A and 1B are depicted in FIGS. 1A and 1B, respectively, as solid lines. On average the curves have at least 2 positive slopes and 1 negative slope in the stress versus probe penetration (%) curve. Probe penetration % is the percent of the thickness through which the probe has penetrated into the sample in the direction of the applied force. The shape and magnitude of the peaks will vary and depend on type (size, shape) and amount of each particulate; and amount of each layer. The peaks correlate to the different senses perceived when a consumer performs a single bite on a sample. For all samples the stress increases as 100% strain is reached due to the fact that the probe is approaching the surface of the platen.

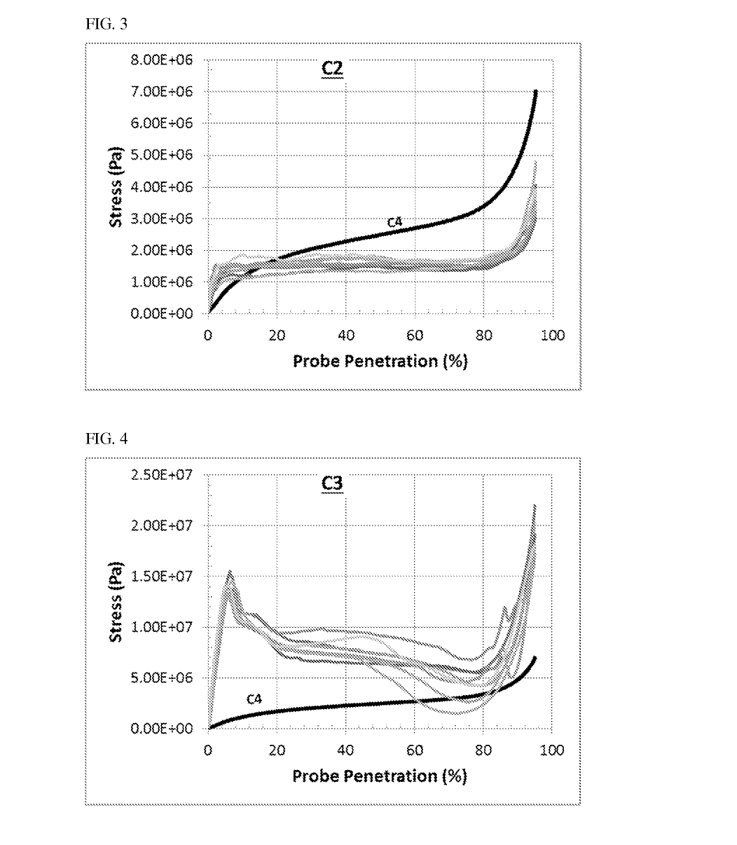

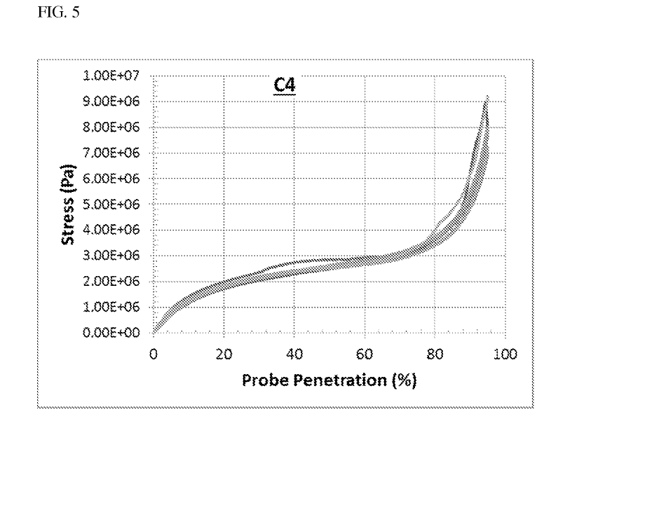

The results of the Initial Crunch, Texture analyzer Test are provided in Table 3 for Examples 1A and 1B along with the results for the comparative chewing gums C1-C4. The reported results take into account an average of the results from the eight runs tested for each sample. FIGS. 1-5 are the stress-strain curves.

In Table 3, the “Ratio of maximum stress value/minimum stress value between 20 and 80% probe penetration” means the ratio of the highest stress value to the lowest stress value within the portion of the stress versus probe penetration (%) curve that corresponds to 20% to 80% probe penetration into the sample.

In Table 3, the “Range 20% to 80%, in million Pa” means the highest stress value minus the lowest stress value reported in million Pascals in the portion of the stress versus probe penetration (%) curve that corresponds to 20% to 80% probe penetration.

The stress versus probe penetration (%) curves may have both negative (downward) and positive (upward) slopes. In Table 3, the question “Are there at least 2 positive slopes and at least one 1 negative slope?” means in the stress versus probe penetration (%) curve are there at least 2 positive (upward) slopes and at least one negative (downward) slope?

In Table 3, the question “Is there at least one negative (downward) slope covering a range of at least 1 million Pa?” asks if the stress is reduced by at least 1 million Pascals from a peak of a negative slope to where the curve changes to a positive slope or the curve ends.

In Table 3, the question “Is at least 2 million Pa stress required between 0 and 10% probe penetration?” asks if the highest stress value between 0 and 10% probe penetration into the sample is at least 2 million pascals.

In Table 3, the question “Is there a stress peak of at least 2 million Pa between 60 and 90% probe penetration?” asks if the highest stress value between 60 and 90% probe penetration into the sample is at least 2 million pascals.

TABLE 3

| | Sample | | | | | |
|---|---|---|---|---|---|---|
| | Example | Example | | | | |
| | 1A | 1B | C1 | C2 | C3 | C4 |
| Ratio of maximum | At least | At least | Less | About 1 | Less | Less |
| stress value/minimum | 1.7 | 1.7 | than 2 | | than 5.5 | than 2 |
| stress value between 20 | | | | | | |
| and 80% probe | | | | | | |
| penetration | | | | | | |
| Range 20% to 80%, in | At least 3 | At least 3 | Less | Less | Less | Less |
| million Pa [high minus | | | than 1.5 | than 0.5 | than 6 | than 2 |
| low] | | | | | | |
| Are there at least 2 | yes | yes | no | yes | yes | no |
| positive slopes and at | | | | | | |
| least 1 negative slope? | | | | | | |
| Is there at least one | yes | yes | no | no | yes | no |
| negative (downward) | | | | | | |
| slope covering a range | | | | | | |
| of at least 1 million Pa? | | | | | | |
| Is at least 2 million Pa | yes | yes | no | no | yes | no |
| stress required between | | | | | | |
| 0 and 10% probe | | | | | | |
| penetration? | | | | | | |
| Is there a stress peak of | yes | yes | no peak | no | no | no peak |
| at least 2 million Pa | | | | | | |
| between 60 and 90% | | | | | | |
| probe penetration? | | | | | | |

As shown in FIG. 1A, the Example 1A chewing gum stress-strain curves exhibit distinct traces as compared to the curve for a conventional chewing gum sample (C4) shown as a dashed line.

The results of the comparative chewing gums are shown in FIGS. 2-5. C1 and C4 differ from the chewing gums of Example 1 by the complete lack of peaks in the stress-strain curve. C2, which is advertised as containing “flavor crystals”, exhibits some minor peaks, but the magnitude is much smaller than what is exhibited by the samples of Example 1. The hard coated pellet gum C3 is the only comparative sample showing the presence of a peak in the stress-strain curve, which is due to the hard outer coating that completely surrounds the chewing gum pellet.

As used herein the terms “comprising” (also “comprises,” etc.), “having,” and “including” is inclusive (open-ended) and does not exclude additional, unrecited elements or method steps. The singular forms “a,” “an,” and “the” include plural referents unless the context clearly dictates otherwise. The endpoints of all ranges directed to the same characteristic or component are independently combinable, and inclusive of the recited endpoint. The term “a combination thereof” is inclusive two or more components of the list. The term “homogeneous” refers to a uniform blend of the components. The terms “first,” “second,” and the like, “primary,” “secondary,” and the like, as used herein do not denote any order, quantity, or importance, but rather are used to distinguish one element from another.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A multi-textured chewing gum product, comprising:
a crunch particulate chewing gum composition layer, and a non-crunch particulate chewing gum composition layer in contiguous contact with the crunch particulate chewing gum composition layer;
the crunch particulate chewing gum composition layer comprising a gum base, a bulk sweetener, and a plurality of crunch particulates distributed throughout the crunch particulate chewing gum composition;
the non-crunch particulate chewing gum composition layer comprising a gum base, a bulk sweetener, and optionally a plurality of color particulates distributed throughout the non-crunch particulate chewing gum composition, where the non-crunch particulate chewing gum composition is free of crunch particulates;
where the multi-textured chewing gum product is uncoated; and
wherein:
i. the multi-textured chewing gum product has an initial crunch characteristic determined by a Texture Analyzer Test where there are at least two positive slopes and at least one negative slope in a stress versus probe penetration (%) curve and at least one negative slope that covers a stress range of at least 0.5, at least 0.75, or at least 1.0 million pascals, wherein the Texture Analyzer Test provides results as stress versus probe penetration (%); or
ii. the multi-textured chewing gum product has an initial crunch characteristic determined by a Texture Analyzer Test that requires at least 2 million pascals stress during the first 10% of probe penetration into the product, wherein the Texture Analyzer Test provides results as stress versus probe penetration (%); or
iii. the multi-textured chewing gum product has an initial crunch characteristic determined by a Texture Analyzer Test where the difference between a maximum stress value and a minimum stress value between 20% and 80% probe penetration into the product is at least 2.5, specifically at least 3.0 million pascals, wherein the Texture Analyzer Test provides results as stress versus probe penetration (%); or
iv. a combination thereof.

2.-4. (canceled)

5. The multi-textured chewing gum product of claim 1, having a stress peak of at least 2, at least 3, at least 4, or at least 5 million pascals between 60% and 90% probe penetration into the product.

6. The multi-textured chewing gum product of claim 1, wherein the crunch particulates are crystalline sugar polyol.

7. The multi-textured chewing gum product of claim 1, wherein the crunch particulates are crystalline isomalt, xylitol, or a combination thereof.

8. The multi-textured chewing gum product of claim 1, wherein the crunch particulates have a particle size of about 0.5 to about 1.4 mm by sieve analysis.

9. The multi-textured chewing gum product of claim 1, wherein the crunch particulates are present in an amount of about 5 to about 30 wt % based on the total weight of the crunch particulate chewing gum composition; or
wherein the crunch particulates are present in an amount of about 2.5 to about 15 wt % based on the total weight of the multi-textured chewing gum product.

10. (canceled)

11. The multi-textured chewing gum product of claim 1, wherein the color particulates are present in an amount of about 0.1 to about 2.0 wt % based on the total weight of the non-crunch particulate chewing gum composition; or
wherein the color particulates are present in an amount of about 0.05 to about 1.0 wt % based on the total weight of the multi-textured chewing gum product.

12. The multi-textured chewing gum product of claim 1, wherein the crunch particulate chewing gum composition, the non-crunch particulate chewing gum composition, or both further comprises an additional ingredient, the additional ingredient is a flavorant, a high intensity sweetener, a food acid or salt thereof, a sensate, a flavor modulator or potentiator, a coloring agent, a humectant, a salt, a softener, or a combination thereof.

13. The multi-textured chewing gum product of claim 1, wherein the crunch particulate chewing gum composition has a different color than the non-crunch particulate chewing gum composition.

14.-15. (canceled)

16. The multi-textured chewing gum product of claim 1, comprising a weight ratio of about 60:40 to about 40:60 crunch particulate chewing gum composition layer to non-crunch particulate chewing gum composition layer.

17. The multi-textured chewing gum product of claim 1, comprising a weight ratio of about 55:45 to about 45:55 crunch particulate chewing gum composition layer to non-crunch particulate chewing gum composition layer.

18.-19. (canceled)

20. A method of making the multi-textured chewing gum product of claim 1, comprising
forming the crunch particulate chewing gum composition;
forming the non-crunch particulate chewing gum composition; and
forming a multi-textured chewing gum having a color particulate chewing gum composition layer in contiguous contact with a non-crunch particulate chewing gum composition layer.

21. A multi-textured chewing gum product, comprising:
at least two chewing gum composition layers,
wherein at least one chewing gum composition layer comprises a plurality of crunch particulates distributed throughout the chewing gum composition, and
optionally where the multi-textured chewing gum product is uncoated; and
wherein
i. the multi-textured chewing gum product has an initial crunch characteristic determined by a Texture Analyzer Test where there are at least two positive slopes and at least one negative slope in a stress versus probe penetration (%) curve and at least one negative slope that covers a stress range of at least 0.5, at least 0.75, or at least 1.0 million pascals, wherein the Texture Analyzer Test provides results as stress versus probe penetration (%); or
ii. the multi-textured chewing gum product has an initial crunch characteristic determined by a Texture Analyzer Test that requires at least 2 million pascals stress during the first 10% of probe penetration into the product, wherein the Texture Analyzer Test provides results as stress versus probe penetration (%); or
iii. the multi-textured chewing gum product has an initial crunch characteristic determined by a Texture Analyzer Test where the difference between a maximum stress value and a minimum stress value between 20% and 80% probe penetration into the product is at least 2.5, specifically at least 3.0 million pascals, wherein the Texture Analyzer Test provides results as stress versus probe penetration (%); or
iv. a combination thereof.

22. (canceled)

23. The multi-textured chewing gum product of claim 21, wherein each chewing gum composition layer comprises a plurality of crunch particulates.

24. The multi-textured chewing gum product of claim 21, wherein the multi-textured chewing gum product comprises two chewing gum composition layers wherein a first chewing gum composition layer comprises a plurality of crunch particulates and a second chewing gum composition layer comprises a plurality of color particulates, a plurality of crunch particulates, or both distributed throughout the second chewing gum composition layer; and the first chewing gum composition layer is in contiguous contact with the second chewing gum composition layer.

25. The multi-textured chewing gum product of claim 21, wherein the crunch particulates are crystalline sugar polyol; or
the crunch particulates are crystalline isomalt, xylitol, or a combination thereof.

26. The multi-textured chewing gum product of claim 21, wherein the crunch particulates have a particle size of about 0.5 to about 1.4 mm by sieve analysis.

27. The multi-textured chewing gum product of claim 21, wherein the crunch particulates are present in an amount of about 2.5 to about 15 wt % based on the total weight of the multi-textured chewing gum product.

28. The multi-textured chewing gum product of claim 21, wherein each chewing gum composition layer comprises a gum base, a bulk sweetener, and optionally an additional ingredient, the additional ingredient is a flavorant, a high intensity sweetener, a food acid or salt thereof, a sensate, a flavor modulator or potentiator, a coloring agent, a humectant, a salt, a softener, or a combination thereof.

29. (canceled)

30. A method of making the multi-textured chewing gum product of claim 21, comprising
forming a first chewing gum composition comprising a plurality of crunch particulates distributed throughout the chewing gum composition;
forming a second chewing gum composition optionally comprising a plurality of color particulates, a plurality of crunch particulates, or both distributed throughout the second chewing gum composition; and
forming a multi-textured chewing gum comprising a first chewing gum composition layer in contiguous contact with a second chewing gum composition layer.
